(19) United States
(12) Patent Application Publication
(10) Pub. No.: US 2024/0292855 A1
(43) Pub. Date: Sep. 5, 2024

(54) FERMENTED NON-DAIRY FOOD COMPOSITION COMPRISING OAT AND FABA PROTEINS

(71) Applicant: SOCIETE DES PRODUITS NESTLE S.A., Vevey (CH)

(72) Inventors: SEBASTIEN RADIGUET, Lisieux (FR); LISE JARNO, Bern (CH); GIULIA MARCHESINI, Saint-Desir (FR); LOUISE MESLIN, La ville du bois (FR); VALERIE MARQUARDT, Froideville (CH); IRMA LIDIA HERNANDEZ GARCIA, Beuvillers (FR); SELENE YADIRA GONZALEZ TOLEDO, Lisieux (FR)

(21) Appl. No.: 18/566,199

(22) PCT Filed: May 31, 2022
(86) PCT No.: PCT/EP2022/064730

§ 371 Date: Dec. 1, 2023

(30) Foreign Application Priority Data
Jun. 1, 2021 (EP) 21177086.2

(51) Int. Cl. A23C 11/10; A23C 9/13

(52) U.S. Cl. CPC A23C 11/103; A23C 9/13

(57) ABSTRACT

The present invention relates to a fermented non-dairy food composition comprising: a) 5-10 wt. % oat, preferably 6-8 wt. % oat, b) 1.5-4 wt. % faba protein, c) 2-5 wt. % vegetable oil, d) water, and e) optionally added water binding fibers and wherein the food composition has a minimum PDCAAS of 0.80, preferably 0.90-0.95.

### FIELD OF THE INVENTION

The present invention relates to fermented food compositions. In particular, the present invention relates to food compositions that can be used as dairy or yoghurt alternatives. Dairy alternatives usually do not comprise dairy proteins. For example, such yoghurt alternatives may comprise plant protein sources. The food composition of the present invention contains oat.

### BACKGROUND

Certain consumers wish to consume less dairy products or do not want to consume milk at all, for example, because of its animal origin, due to lactose intolerance or due to dairy allergies. They may also see potential environmental sustainability issues. As a consequence, consumers seek alternatives to dairy products. Alternatives to milk do exist and the dairy alternatives market is growing by 11% each year and finding an alternative with good nutrition and taste will be a major advantage in this competitive field.

WO 2013078510 discloses a nut-based milk analogue composition that has a substantially similar nutritional profile as cow milk.

CA2982280 discloses a method of producing a milk alternative, without necessarily adding a gum or emulsifier or starch, using chickpeas and/or other whole legumes or lentils (regular, sprouted or fermented), using pea protein, chickpea protein and/or a combination of plant-based protein (regular, sprouted or fermented), using flax seed oil and/or other vegetable oil, through high rotation mixing, heat and pressure, producing a very smooth mouthfeel.

Pea protein containing milk alternatives are commercially available. Furthermore, soy protein containing yoghurt alternatives are commercially available.

However, consumers increasingly search for food compositions that can be used as dairy alternatives that have an excellent nutritional value and a pleasant taste profile. In particular, there is a need for fermented food compositions as yoghurt analogues that are high in protein, fiber and calcium.

Plant-based foods is a significant alternative to dairy foods. In particular, plant-derived milk analogues and fermented non-dairy analogues (yoghurt analogues, non-dairy beverages and cheese analogues) are becoming increasingly important products.

Plant-based proteins are often not as good in quality as dairy proteins. The protein digestibility-corrected amino acid score (PDCAAS) is a method of evaluating the quality of a protein based on both the amino acid requirements of humans and their ability to digest it. PDCAAS compares the amount of the essential amino acids in a food to a reference (scoring) pattern based on the essential amino acid requirements of a preschool-age child to determine its most limiting amino acid (amino acid score). This approach is recommended by the Food and Drug Administration (FDA) and is described in the 1991 FAO/WHO Protein Quality Report.

When using the PDCAAS method, the highest possible score is a 1.0 meaning, that after digestion, a protein having a PDCAAS of 1.0 provides (per unit of protein) 100% or more of the indispensable amino acids required. Whereas cow's milk and casein (milk protein) have a PDCAAS of 1.0, the PDCAAS of many plant-based proteins is often less than 1.0. It is therefore desirable to provide a plant-based nutritional composition, which is free from any dairy ingredients, having a satisfactory texture and taste, an improved PDCAAS and little or no added sugar.

In particular the inclusion of fiber while maintaining a pleasant taste and texture profile appears to be difficult for the applications with plant proteins. In accordance with this US20130196028A1 discloses a method of making a chickpea soluble fraction, but which includes the removal of dietary fiber by filtration.

Also, if milk protein is replaced by plant protein sources, this often results in an unpleasant taste, and the composition can be perceived as bitter and/or astringent.

It would therefore be desirable to provide a fermented food composition that can be used as yoghurt alternative, contains fiber and that has a good nutritional profile, a good PDCAAS and taste profile.

Any reference to prior art documents in this specification is not to be considered an admission that such prior art is widely known or forms part of the common general knowledge in the field.

### OBJECT OF THE INVENTION

The objective of the present invention is it to improve the state of the art and in particular to provide a fermented food composition that can be used as dairy alternative and that is a source of protein, fiber and calcium, that provides a good nutritional profile, and a good taste profile.

### SUMMARY OF THE INVENTION

The present invention provides the improvement by the subject matter of the independent claims. The dependent claims further develop the idea of the present invention.

In a first aspect, the invention relates to a fermented non-dairy food composition comprising 5-10 wt. % oat, 1.5-4 wt. % faba protein, 2-5 wt. % vegetable oil, water, preferably 80-90 wt. %, more preferably 80-85 wt. % water, and optionally added citrus fibers, preferably 0.1-0.5 wt. % water binding fibers, wherein the food composition has a minimum PDCAAS of 0.80, preferably 0.90-0.95.

Oats are an excellent source of dietary fiber and are brought into association with many health benefits, such as—for example—a reduction of serum cholesterol levels in the body. Oats contain more soluble fiber than most other grains and are high in protein and healthy fats, and lower in carbohydrates than most other whole grains. Consequently, many breakfasts, such as porridge, for example are based on oats and several breakfast cereals are based on oats as well.

To provide a good nutritional profile of the food, oats are present in the composition of the present invention. According to the invention it was found that it was possible without any substantial negative impact on the flavor profile and texture of the composition to include large amounts of oat in the food composition.

As used in this specification, the words “comprises”, “comprising”, and similar words, are not to be interpreted in an exclusive or exhaustive sense. In other words, they are intended to mean “including, but not limited to”.

The present inventors have shown that the composition of the present invention achieves the objective of the present invention and—in particular—that a fermented food composition comprising oat and faba protein isolate, vegetable oil, a source of calcium for fortification, and wherein the food composition does not comprise dairy protein, is free from stabilizing gums and has a pH below 4.6, preferably a pH of 4.4-4.6, can be source of protein, source of calcium and containing a live culture and achieves the objective of the present invention.

The composition of the present invention was found to have a surprisingly pleasant taste profile despite the level of plant protein. The composition of the present invention was further found to have a surprisingly creamy texture and being stable in chilled storage.

### BRIEF DESCRIPTION OF THE DRAWINGS

FIG. 1 is a photo of a sample of the food composition according to the invention.

FIG. 2 is a photo of samples giving during a tasting session to panelists.

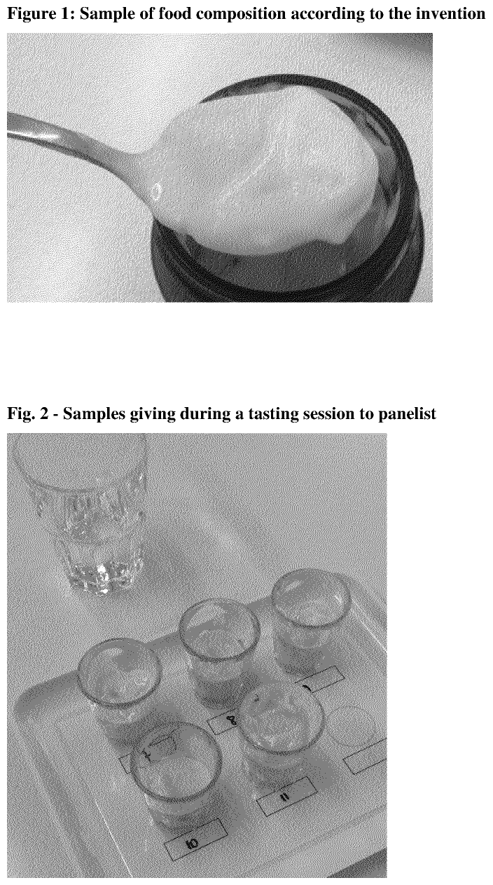

### DETAILED DESCRIPTION OF THE INVENTION

Consequently, the present invention relates to a fermented non-dairy food composition comprising 5-10 wt. % oat, 1.5-4 wt. % faba protein, 2-5 wt. % vegetable oil, water, and optionally added water binding fibers, preferably 0.1-0.5 wt. % water binding fibers, more preferably 0.1-0.5 wt. % citrus fibers, and wherein the food composition has a minimum PDCAAS of 0.80, preferably 0.90-0.95.

The water content in the fermented non-dairy food composition may be adapted according to the desired thickness of the product. Preferably the food composition comprises 80-90 wt. % water, and more preferably 80-85 wt. % water.

Current milk alternative products on the market are poor in terms of protein quality requirements, such as protein-digestibility corrected amino acid score (PDCAAS). To reach a protein quality close to that of milk (PDCAAS=1), plant proteins with complementary amino acids are combined. For example, according to the present invention a combination of 30% oat protein with 70% faba bean protein allows reaching a PDCAAS>0.9.

The fermented food composition in accordance with the present invention does not comprise dairy protein or stabilizing agents.

The term “food” shall be understood in accordance with Codex Alimentarius as any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

For the purpose of the present invention, a food may be considered a source of fibres when the product contains at least 3 g of fibre per 100 g or at least 1.5 g of fibre per 100 kcal.

For the purpose of the present invention, a food may be considered a source of protein when at least 12% of the energy value of the food is provided by protein. For the purpose of the present invention, a food may be considered high in calcium, if the product contains at least twice the value of ‘source of calcium’. A food may be considered a ‘source of calcium’ if the product contains at least a significant amount as defined in the Annex to Directive 90/496/EEC or an amount provided for by derogations granted according to Article 6 of Regulation (EC) No 1925/2006 of the European Parliament and of the Council of 20 Dec. 2006 on the addition of vitamins and minerals and of certain other substances to foods. 15% of the recommended allowance supplied by 100 g or 100 ml or per package if the package contains only a single portion should be taken into consideration in deciding what constitutes a significant amount.

Faba (fava) protein is commercially available from ingredient suppliers.

Dairy proteins are milk proteins synthesized in the mammary gland and comprise caseins and whey proteins. For example, dairy proteins may comprise caseins, β-lactoglobulin, α-lactalbumin, blood serum albumin, immunoglobulins, lactoferrin, and transferrin.

In a preferred embodiment of the invention the fermented non-dairy food composition has a pH below 4.6, preferably a pH of 4.4-4.6. The pH level may be obtained via the fermentation of the product and provides a safe product when the pH is below 4.6. To obtain an agreeable and not too sour product, the pH is preferably in the range of 4.0-4.6.

In a preferred embodiment of the invention, the fermented non-dairy food composition the oat is selected from the group consisting of non-hydrolyzed oat flour, hydrolyzed oat flour, oat concentrates, oat isolates or a combination thereof.

Advantageously, the fermented non-dairy food composition according to the invention comprises the oat being a combination of non-hydrolyzed oat flour and hydrolyzed oat flour. In particular, it is preferred that the fermented non-dairy food composition comprises 1.0-3.0 wt. % non-hydrolyzed oat flour and 4.0-6.0 wt. % hydrolyzed oat flour.

This combination of oat has been found to provide a natural thickening of the food composition without the need for thickening agents. It has also been found that when water binding fibers, in particular citrus fiber, is present in the composition it supports the texture and creaminess of the product.

Typically, oat flour comprises 10-15% protein in flour. However, defatted oat may be used when there is a wish for a high protein product. Defatted oat may comprise up to about 19 wt. % protein.

For improved nutritional profile of the product the oat flour is preferably non-hydrolyzed or hydrolyzed whole grain oat flour.

According to the present invention, the fermented non-dairy food composition comprise faba protein that is preferably from a protein source selected from the group consisting of protein isolate, protein concentrate, faba flour or a combination there of.

Advantageously, the faba protein is present in an amount of 1.5-3 wt. %, preferably in the form of a faba protein isolate.

In one embodiment of the invention the fermented non-dairy food composition comprises 1.5-6.0 wt. % added sugar, preferably 1.5-4.0 wt. % added sugar, more preferably 2.5 to 3.5 wt. % added sugar.

Added sugar is used in the composition of the present invention to adjust the sweetness. Many sugars can be used for this purpose. Preferably the sugar is from sugar cane or beet. For example, the sugar used in the framework of the present invention, may be cane sugar. Cane sugar, in particular unprocessed cane sugar may contain small amounts of essential minerals and/or a certain amount of antioxidants.

In an alternative embodiment of the invention, no sugar is added. This may be a desirable solution if a low sugar product is needed. However, it may require a longer fermentation process.

The food composition according to the invention may be fermented with at least one lactic acid-producing bacteria selected from the group consisting of: Lactobacillus, Leuconostoc, Pediococcus, Lactococcus, Streptococcus, Aerococcus, Bifidobacterium, Carnobacterium, Enterococcus, Oenococcus, Sporolactobacillus, Tetragenococcus, Vagococcus, and Weissella, preferably selected from the group consisting of Lactobacillus, Lactococcus, Streptococcus, and Bifidobacterium, further preferably selected from the group Lactobacillus, Streptococcus and Lactococcus, most preferably Streptococcus and Lactobacillus. The fermentation may be performed until the pH is below 4.6.

The food composition in accordance with the present invention may be adjusted so that the final composition has a good taste profile, a good nutritional profile and resembles the appearance and texture of dairy yoghurt. It has been found that good results are obtained with a composition wherein the composition comprises 0.3-0.5 g calcium source for fortification.

It is preferred that the calcium source for fortification is selected from the group consisting of tri-calcium phosphate, calcium carbonate, calcium lactate, calcium chloride, calcium lactogluconate, di-calcium phosphate, tri-calcium citrate or a combination thereof.

Optionally, the food composition according to the invention comprises fibers from a source of fibers selected from the group consisting of chicory root, sugar beetroot, sugar cane, Jerusalem artichoke or combination thereof, and wherein the fibers are preferably inulin from chicory root. These fibers support the nutritional profile of the product.

In a particular preferred embodiment of the food composition according to the invention it comprises water binding fibers. This may provide additional texture e.g. if the filling of the food composition is done after fermentation. A filling into packages after fermentation may destroy some texture created by the fermentation process.

The water binding fibers are preferably selected from the group consisting of citrus fibers, coconut fibers, carrot fibers, pea fibers or a combination thereof.

Preferably the food composition comprises 0.1-0.5 wt. % water binding fibers. It is preferred that the water biding fibers are citrus fibers. Citrus fibers furthermore is a source of fiber in the product.

Optionally the food composition according to the invention further comprises a flavoring agent or flavoring agents. The flavoring agents are then preferably selected from the group consisting of milk mouthfeel flavor, vanilla flavor, coconut flavor, almond flavor, fruit flavors or combinations thereof.

It is preferred that the vegetable oil or fat is high oleic vegetable oil, preferably high oleic sunflower oil. As sunflower oil, any sunflower oil may be used. High quality sunflower oils are preferred. Sunflower oil can be considered a healthy oil with a high stability. Sunflower oil has a rich content of vitamin E. It also has a good fatty acid profile containing linoleic acid a polyunsaturated fatty acid and with oleic acid a monounsaturated fatty acid. It is well-known that, for example through a specific cultivation of the sunflowers and through adjusted manufacturing processes, oils with different fatty acid proportions can be manufactured. Oleic acid has been associated with several health benefits such as decreased low-density lipoprotein (LDL) cholesterol, and reduced blood pressure, for example. Hence, some consumers may prefer an oil with a high oleic acid content. High oleic sunflower oil is known and commercially available. High oleic sunflower oil is very high in oleic acid. High oleic sunflower oil is usually defined as having a minimum 80 percent oleic acid. Consequently, in one embodiment of the food composition of the present invention the sunflower oil may be high oleic sunflower oil. Similar considerations apply to rapeseed oil, and in a preferred embodiment of the food composition it comprises rapeseed oil.

The vegetable oil or fat is selected from the group consisting of high oleic vegetable oil, preferably high oleic rapeseed or sunflower oil, coconut oil, nut and seed oil or fats, or a combination thereof.

In a preferred embodiment of the food composition according to the invention it comprises 3-4 wt. % vegetable oil or fat.

The fermented non-dairy food composition according to the invention preferably has an energy density in the range of 40-90 kcal/100 grams.

Milk and milk yoghurt are rich sources of nutrition. As such it provides good amounts of many of the nutrients necessary for the growth and maintenance of the human body. Many consumers would hence prefer, a milk or yoghurt alternative to also have a good nutritional profile.

In view of this, the food composition of the present invention may be a source of protein, a source of fiber and/or high in calcium.

For example, the food composition of the present invention may comprise per 100 g about 2.5-3 g protein, about 2.8-3.2 g fat, about 7-10 g carbohydrates.

The composition of the present invention may further be enriched with vitamins, for example vitamins A, D, B2, and/or B12.

For example, the food composition in accordance with the present invention may comprise vitamins selected from the group consisting of vitamin A, vitamin D, vitamin B2 and vitamin B12. In one embodiment of the present invention, the liquid food composition of the present invention may comprise per 100 ml 120-170 mg calcium, 120-170 μg vitamin A, 0.75-1.2 μg vitamin D, 0.21-0.30 mg vitamin B2 and/or 0.38-0.6 μg vitamin B12.

In a preferred embodiment of the invention the fermented non-dairy food composition comprises vitamins selected from the group consisting of vitamin A, vitamin D, vitamin B2 and vitamin B12.

Advantageously, the fermented non-dairy food composition according to the invention comprises per 100 grams 120-170 mg calcium, 0.75-1.2 μg vitamin D, 0.21-0.30 mg vitamin B2 and/or 0.38-0.6 μg vitamin B12.

In a preferred embodiment of the invention the fermented non-dairy food composition is free of pea protein.

The non-dairy food composition according to the invention may be produced with a process comprising the steps of
(a) mixing the oat and faba protein with water to obtain a plant-based liquid solution,
(b) mixing the plant-based liquid solution with vegetable oil or fat to obtain a plant-based liquid emulsion,
(c) homogenizing the plant-based liquid emulsion at a pressure ranging from 50 bar to 700 bar to obtain a homogenized plant-based liquid emulsion
(d) heat-treating the homogenized plant-based liquid emulsion at a temperature ranging from 80° C. to 100° for a time ranging from 1 minute to 10 minutes,
(e) inoculating the homogenized plant-based liquid emulsion with at least one non-dairy starter culture,
(f) fermenting the homogenized plant-based liquid emulsion to a pH below 4.6.

A fermentable sugar is preferable added in step (a).

A pasteurization step may optionally be added to allow for a shelf stable variant of the product.

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred to in this specification. Further advantages and features of the present invention are apparent from the figures and non-limiting examples.

### Examples

### Examples—Product Evaluation

The product evaluation was done in tasting sessions by a panel of experts of at least five persons, judging appearance, odor, taste, texture and aftertaste and giving an overall liking score of the product. Furthermore, open comments on what was liked or disliked were collected.

Product evaluation was done by an expert panel rating the overall liking with a score from 1 to 5, and assessing appearance, odor, taste, texture, aftertaste. 1—dislike a lot; 2—somewhat dislike it; 3—neither like or dislike; 4—somewhat like it; 5—like it a lot.

The products assessed in the examples were made with a standard yoghurt production method: Mixing ingredient (10 min at room temperature and 20 min at 60° C.), homogenization (200 bar), pasteurization (92° C. during 6 min), fermentation (at 40° C. about 3 h30), and smoothing (1 bar CPM).

### Example 1—Assessment of Fat Source

| Recipe 1.1 | |
|---|---|
| Ingredients | Quantity (%) |
| Whole grain oat flour | 3 |
| Whole grain hydrolyzed oat flour | 3.5 |
| Faba bean protein ingredient | 2 |
| Sugar | 3 |
| Sunflower oil | 3 |
| Total | 14.5 |
| Water | 85.5 |

Recipe 1.1 is a fermented product based on oat and faba protein according to the invention. Sunflower oil was used as source of fat. Result of tasting was good.

Recipe 1.2

| Ingredients | Quantity (%) |
|---|---|
| Whole grain oat flour | 1.5 |
| Whole grain hydrolyzed oat flour | 5.5 |
| Faba bean protein ingredient | 2.7 |
| Sugar | 3 |
| Rapeseed oil | 3 |
| Total | 15.7 |
| Water | 84.3 |

Recipe 1.2 is a fermented preparation based on oat and faba protein according to the invention. Rapeseed oil was used as source of fat. Result of tasting was good.

| Recipe 1.3: olive oil | Quantity | Protein |
|---|---|---|
| Ingredients | (%) | contribution |
| Whole grain oat flour | 2 | 0.2 |
| Whole grain hydrolyzed oat flour | 5 | 0.6 |
| Faba bean protein ingredient | 2 | 1.7 |
| Sugar | 3 | |
| Olive oil | 3 | |
| Total | 15 | 2.5 |
| Water | 85 | |

Recipe 1.3 is a fermented preparation based on oat and faba. Olive oil was used as source of fat. Results of tasting in term of odor, taste and aftertaste, olive oil was giving a savory direction to product. The product is not according to the invention.

In example 1 it was found that vegetable oil or fat with a 3% contribution in the recipe is delivering the desired texture for a plant-based product as alternative to yoghurt.

### Example 2—Ratio Between Ingredient that are Source of Proteins and Impact on Taste and Texture of Final Product

| Recipe 2.1 | Quantity | Protein |
|---|---|---|
| Ingredients | (%) | contribution |
| Whole grain oat flour | 2 | 0.2 |
| Whole grain hydrolyzed oat flour | 5 | 0.6 |
| Faba bean protein ingredient | 2 | 1.7 |
| Sugar | 3 | |
| Vegetable fat | 3 | |
| Total | 15 | 2.5 |
| Water | 85 | |

Recipe 2.1 is a fermented preparation based on oat and faba protein according to the invention. The ratio between oat ingredients was assessed. The tasting panel found that the products were good especially in terms of texture.

| Recipe 2.2 | Quantity | Protein |
|---|---|---|
| Ingredients | (%) | contribution |
| Whole grain oat flour | 2 | 0.2 |
| Whole grain hydrolyzed oat flour | 7 | 0.6 |
| Faba bean protein ingredient | 2 | 1.7 |
| Sugar | 3 | |
| Vegetable fat | 3 | |
| Total | 17 | 2.5 |
| Water | 83 | |

Recipe 2.2 is a fermented preparation based on oat and faba protein according to the invention. The ratio between oat ingredients was assessed. Result of tasting was good especially in term of texture.

Recipe 2.3

| Ingredients | Quantity (%) | Protein contribution |
|---|---|---|
| Whole grain oat flour | 2 | 0.2 |
| Whole grain hydrolyzed oat flour | 7 | 0.6 |
| Faba bean protein ingredient | 2.8 | 1.7 |
| Sugar | 3 | |
| Vegetable fat | 3 | |
| Total | 17.8 | 2.5 |
| Water | 82.2 | |

Recipe 2.3 is a fermented preparation based on oat and faba protein according to the invention. The preparation with a higher protein content coming from faba was assessed. Result of tasting was acceptable.

Recipe 2.4

| Ingredients | Quantity (%) | Protein contribution |
|---|---|---|
| Whole grain oat flour | 2.5 | 0.3 |
| Whole grain hydrolyzed oat flour | 5 | 0.6 |
| Faba bean protein ingredient | 2 | 1.7 |
| Sugar | 3 | |
| Vegetable fat | 3 | |
| Total | 15.5 | 2.6 |
| Water | 84.5 | |

Recipe 2.4 is a fermented preparation based on oat and faba protein according to the invention. The ratio between oat ingredients was assessed. Result of tasting was good especially for taste and texture.

Recipe 2.5

| Ingredients | Quantity (%) | Protein contribution |
|---|---|---|
| Whole grain oat flour | 2 | 0.2 |
| Whole grain hydrolyzed oat flour | 5 | 0.6 |
| Faba bean protein ingredient | 2.1 | 1.8 |
| Sugar | 3 | |
| Vegetable fat | 3 | |
| Total | 15.1 | 2.6 |
| Water | 84.9 | |

Recipe 2.5 is a fermented preparation based on oat and faba according to the invention. The ratio between oat ingredients was assessed. Result of tasting was good.

Recipe 2.6

| Ingredients | Quantity (%) | Protein contribution |
|---|---|---|
| Whole grain oat flour | 6 | 0.7 |
| Whole grain hydrolyzed oat flour | | 0 |
| Faba bean protein ingredient | 2.1 | 1.8 |
| Sugar | 3 | |
| Rapeseed oil | 3 | |
| Total | 14.1 | 2.5 |
| Water | 85.9 | |

Recipe 2.6 is a fermented preparation based on oat and faba protein. Only non-hydrolyzed oat flour was used. The result of the tasting was less acceptable and was for certain applications considered too thick and dense.

It was found that with the right level of oat and faba protein a good sensory profile is present with 5 to 10% oat ingredients, preferably 6 to 8% oat ingredients and 1.5 to 4% of faba protein.

The example shows that having a combination of non-hydrolyzed whole grain oat flour and hydrolyzed whole grain oat flour as oat sources may provide desirable benefits in terms texture.

### Example 3—Source of Protein

Recipe 3.1

| Ingredients | Quantity (%) | Protein contribution |
|---|---|---|
| Whole grain oat flour | 2 | 0.2 |
| Whole grain hydrolyzed oat flour | 5 | 0.6 |
| Faba bean protein ingredient | 2.1 | 1.8 |
| Sugar | 3 | |
| Vegetable fat | 3 | |
| Total | 15.1 | 2.6 |
| Water | 84.9 | |

Recipe 3.1 is a fermented preparation based on oat and faba protein with 2.6% total protein according to the invention.

Recipe 3.2

| Ingredients | Quantity (%) | Protein contribution |
|---|---|---|
| Whole grain oat flour | 2 | 0.2 |
| Whole grain hydrolyzed oat flour | 7 | 0.6 |
| Pea protein ingredient 1 | 2.1 | 1.7 |
| Sugar | 3 | |
| Rapeseed oil | 3 | |
| Total | 17.1 | 2.5 |
| Water | 82.9 | |

Recipe 3.2 is a fermented preparation based on oat and pea protein ingredient 1 at a selected specific ratio to achieve 2.5% total protein.

Recipe 3.3

| Ingredients | Quantity (%) | Protein contribution |
|---|---|---|
| Whole grain oat flour | 2 | 0.2 |
| Whole grain hydrolyzed oat flour | 5.5 | 0.7 |
| Pea protein ingredient 1 | 2 | 1.6 |
| Sugar | 3 | |
| Colza oil | 3 | |
| Total | 15.5 | 2.5 |
| Water | 84.5 | |

Recipe 3.3 is a fermented preparation based on oat and pea protein ingredient 1 at an alternative specific ratio to achieve 2.5% total protein.

Recipe 3.4

| Ingredients | Quantity (%) | Protein contribution |
|---|---|---|
| Whole grain oat flour | 2 | 0.2 |
| Whole grain hydrolyzed oat flour | 7 | 0.6 |
| Pea protein ingredient 2 | 2.1 | 1.7 |
| Sugar | 3 | |
| Rapeseed oil | 3 | |
| Total | 17.1 | 2.5 |
| Water | 82.9 | |

Recipe 3.4 is a fermented preparation based on oat and pea protein ingredient 2 at a selected specific ratio to achieve 2.5% total protein.

Recipe 3.5

| Ingredients | Quantity (%) | Protein contribution |
|---|---|---|
| Whole grain oat flour | 6 | 0.7 |
| Whole grain hydrolyzed oat flour | | 0 |
| Pea protein ingredient | 2.3 | 1.9 |
| Sugar | 3 | |
| Rapeseed oil | 3 | |
| Total | 14.3 | 2.6 |
| Water | 85.7 | |

Recipe 3.5 is a fermented preparation based on oat and pea protein ingredient at a selected specific ratio to achieve 2.6% total protein, but without using hydrolyzed oat flour.

It was found that with a fermented preparation based on either the combination of pea and oat, or the combination of pea and faba the protein source has an impact on sensory outcomes. The products comprise similar protein quality and quantity. Results of tasting sessions showed that pea protein combined with oat was less accepted than faba protein combined with oat. The oat and faba protein fermented preparation was delivering better in terms of odor, taste and aftertaste with a higher overall liking score.

Moreover, the last recipe shows that similarly to example 2, in these preferred embodiments the importance of having a combination between hydrolyzed oat flour and non-hydrolyzed oat flour is shown.

### Example 4—Texture

Recipe 4.1

| Ingredients | Quantity (%) | Protein contribution |
|---|---|---|
| Whole grain oat flour | 2.1 | 0.2 |
| Whole grain hydrolyzed oat flour | 5.1 | 0.6 |
| Faba protein ingredient | 2.35 | 2 |
| Sugar | 3 | |
| Vegetable fat | 3 | |
| Pectin | 0.5 | |
| Total | 25.55 | 2.8 |
| Water | 74.45 | |

Recipe 4.2

| Ingredients | Quantity (%) | Protein contribution |
|---|---|---|
| Whole grain oat flour | 2.1 | 0.2 |
| Whole grain hydrolyzed oat flour | 5.1 | 0.6 |
| Faba protein ingredient | 2.35 | 2.8 |
| Sugar | 3 | |
| Vegetable fat | 3 | |
| Starch | 2 | |
| Total | 17.55 | 2.8 |
| Water | 82.45 | |

Recipes 4.1 and 4.2 are fermented preparations based on oat and faba protein. Pectin and starch are present in the product. For both recipes, the results were good in terms of texture improvement but the taste was impacted.

Recipe 4.3

| Ingredients | Quantity (%) | Protein contribution |
|---|---|---|
| Whole grain oat flour | 2.1 | 0.2 |
| Whole grain hydrolyzed oat flour | 5.1 | 0.6 |
| Faba protein ingredient | 2.35 | 2 |
| Sugar | 3 | |
| Vegetable fat | 3 | |
| Citrus fiber | 0.1 | |
| Total | 15.65 | 2.8 |
| Water | 84.35 | |

Recipe 4.3 is a fermented preparation based on oat and faba according to the invention. Citrus fiber was used in the preparation. The impact on texture was good.

Recipe 4.4

| Ingredients | Quantity (%) | Protein contribution |
|---|---|---|
| Whole grain oat flour | 2.1 | 0.2 |
| Whole grain hydrolyzed oat flour | 5.1 | 0.6 |
| Faba protein ingredient | 2.35 | 2 |
| Sugar | 3 | |
| Vegetable fat | 3 | |
| Citrus fiber | 0.2 | |
| Total | 15.65 | 2.8 |
| Water | 84.35 | |

Recipe 4.5

| Ingredients | Quantity (%) | Protein contribution |
|---|---|---|
| Whole grain oat flour | 2.1 | 0.2 |
| Whole grain hydrolyzed oat flour | 5.1 | 0.6 |
| Faba protein ingredient | 2.35 | 2 |
| Sugar | 3 | |
| Vegetable fat | 3 | |
| Citrus fiber | 0.3 | |
| Total | 15.65 | 2.8 |
| Water | 84.35 | |

Different concentrations of citrus fiber are present in recipe 4.4 and 4.5. Results were good for all recipes in terms of taste and texture.

This example shows that an addition of 0.1 to 0.5% of citrus fiber in the recipe gives the expected sensory profile. To assess and compare the physical viscosity of the recipes of this cluster, each recipe has been measured using a Bostwick viscosimeter. Results are presented below and show the positive impact of citrus fiber on viscosity:

| Recipes | cm/30 sec |
|---|---|
| Recipe 4.1 | 9.8 |
| Recipe 4.2 | 4.5 |
| Recipe 4.3 | 5.5 |
| Recipe 4.4 | 4.5 |
| Recipe 4.5 | 3.9 |

1. Fermented non-dairy food composition comprising
a. 5-10 wt. % oat, preferably 6-8 wt. % oat,
b. 1.5-4 wt. % faba protein,
c. 2-5 wt. % vegetable oil or fat,
d. water, and
the food composition has a minimum PDCAAS of 0.80.

2. Fermented non-dairy food composition according to claim 1, wherein the food composition has a pH below 4.6.

3. Fermented non-dairy food composition according to claim 1, wherein the fermented food composition does not comprise any dairy protein.

4. Fermented non-dairy food composition according to claim 1, wherein the oat is selected from the group consisting of non-hydrolyzed oat flour, hydrolyzed oat flour, oat concentrates, oat isolates and a combination thereof.

5. Fermented non-dairy food composition according to claim 1, wherein the oat is a combination of non-hydrolyzed oat flour and hydrolyzed oat flour.

6. Fermented non-dairy food composition according to claim 1, wherein the faba protein is selected from the group consisting of protein isolate, protein concentrate, faba flour and a combination thereof.

7. Fermented non-dairy food composition according to claim 1, wherein faba protein present in an amount of 1.5-3 wt. % faba protein.

8. Fermented non-dairy food composition according to claim 1, wherein the composition comprises 1.5-6.0 wt. % added sugar.

9. Fermented non-dairy food composition according to claim 1, comprising 0.3-0.5 g calcium source for fortification.

10. Fermented non-dairy food composition according to claim 1, wherein the calcium source for fortification is selected from the group consisting of tri-calcium phosphate, calcium carbonate, calcium lactate, calcium chloride, calcium lactogluconate, di-calcium phosphate, tri-calcium citrate and a combination thereof.

11. Fermented non-dairy food composition according to claim 1, wherein the vegetable oil or fat is selected from the group consisting of high oleic vegetable oil, preferably high oleic rapeseed or sunflower oil, coconut oil, nut and seed oil or fats, and a combination thereof.

12. Fermented non-dairy food composition according to claim 1, wherein the food composition has an energy density in the range of about 50-90 kcal/100 grams.

13. Fermented non-dairy food composition according to claim 1, further comprising vitamins selected from the group consisting of vitamin A, vitamin D, vitamin B2 and vitamin B12.

14. Fermented non-dairy food composition according to claim 1, wherein the food composition comprises per 100 grams 120-170 mg calcium, 0.75-1.2 μg vitamin D, 0.21-0.30 mg vitamin B2 and/or 0.38-0.6 μg vitamin B12.

15. Fermented non-dairy food composition according to claim 1, wherein the oat and the faba protein are the only plant proteins in the food composition other than protein contributed by optionally added fruit or nuts.

16. Fermented non-dairy food composition according to claim 1, wherein the food composition is to be used as a plant-based yoghurt alternative.
